(19) United States
(12) Patent Application Publication
(10) Pub. No.: US 2025/0379454 A1
(43) Pub. Date: Dec. 11, 2025

(54) POWER SUPPLY SYSTEM AND MOVING OBJECT

(71) Applicant: HONDA MOTOR CO., LTD., Tokyo (JP)

(72) Inventor: Kenta Shuto, Wako-shi (JP)

(21) Appl. No.: 19/213,218

(22) Filed: May 20, 2025

(30) Foreign Application Priority Data
Jun. 6, 2024 (JP) 2024-091894

(51) Int. Cl. H02J 7/00; B64C 29/00; B64D 27/34; B64D 27/35

(52) U.S. Cl. CPC H02J 7/0013; B64C 29/00; B64D 27/34; B64D 27/35; B64D 2221/00

(57) ABSTRACT

An electrical power supply system includes a first electrical power supply circuit that supplies, to a first load device a DC electrical power output from a first electrical power generating device, a second electrical power supply circuit that supplies, to a second load device, a DC electrical power output from a second electrical power generating device, a first connection circuit including a first connection device capable of connecting the first electrical power supply circuit and the second electrical power supply circuit, a first electrical power storage device connected, in parallel with the first electrical power generating device, to the first electrical power supply circuit, and a second electrical power storage device connected, in parallel with the first electrical power generating device, to the first connection circuit, and having a rated output voltage lower than that of the first electrical power storage device.

### CROSS-REFERENCE TO RELATED APPLICATIONS

This application is based upon and claims the benefit of priority from Japanese Patent Application No. 2024-091894 filed on Jun. 6, 2024, the contents of which are incorporated herein by reference.

### BACKGROUND OF THE INVENTION

### Field of the Invention

The present disclosure relates to an electrical power supply system and a moving object.

### Description of the Related Art

In JP 2022-529997 A, an aircraft electrical energy supply network is disclosed. Such an electrical energy supply network is equipped with a first circuit including a first electrical power generator and a first electrical load, a second circuit including a second electrical power generator and a second electrical load, and a distribution bus that connects the first circuit and the second circuit.

### SUMMARY OF THE INVENTION

In techniques related to electrification technologies, there is a long-awaited need for a more satisfactory electrical power supply system, and a moving object including a more satisfactory electrical power supply system.

The present invention has the object of solving the aforementioned problem.

A first aspect of the present disclosure is characterized by an electrical power supply system, comprising a first electrical power supply circuit configured to supply, to a first load device, a direct-current electrical power output from a first electrical power generating device, a second electrical power supply circuit configured to supply, to a second load device, a direct-current electrical power output from a second electrical power generating device, a first connection circuit equipped with a first connection device configured to connect the first electrical power supply circuit and the second electrical power supply circuit, a first electrical power storage device connected, in parallel with the first electrical power generating device, to the first electrical power supply circuit, and a second electrical power storage device connected, in parallel with the first electrical power generating device, to the first connection circuit, the second electrical power storage device having a rated output voltage lower than a rated output voltage of the first electrical power storage device.

A second aspect of the present invention is characterized by an electrical power supply system, comprising an electrical power supply circuit configured to supply, to a load device, a direct-current electrical power output from an electrical power generating device, a first electrical power storage device connected, in parallel with the electrical power generating device, to the electrical power supply circuit, a reverse flow prevention device provided in the electrical power supply circuit, and configured to limit supply of an electrical power from the first electrical power storage device to the electrical power generating device, and a second electrical power storage device connected, in parallel with the electrical power generating device, to a portion of the electrical power supply circuit that is positioned between the electrical power generating device and the reverse flow prevention device, the second electrical power storage device having a rated output voltage lower than a rated output voltage of the first electrical power storage device.

A third aspect of the present disclosure is characterized by a moving object comprising the electrical power supply system according to the first aspect or the second aspect.

According to the present disclosure, it is possible to provide a more satisfactory electrical power supply system and a moving object including a more satisfactory electrical power supply system.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a schematic diagram of an electrical power supply system according to a first embodiment;

FIG. 2 is a schematic diagram of an electrical power supply system according to a second embodiment.

FIG. 3 is a diagram showing operations of the electrical power supply system at a normal time;

FIG. 4 is a diagram showing operations of the electrical power supply system at a time of a first abnormality;

FIG. 5 is a diagram showing operations of the electrical power supply system at a time of a second abnormality;

FIG. 6 is a schematic diagram of an electrical power supply system according to a third embodiment;

FIG. 7 is a control block diagram of a control device according to the first embodiment to the third embodiment; and

FIG. 8 is a schematic diagram of a moving object.

### DETAILED DESCRIPTION OF THE INVENTION

### [Configuration of Electrical Power Supply System in First Embodiment]

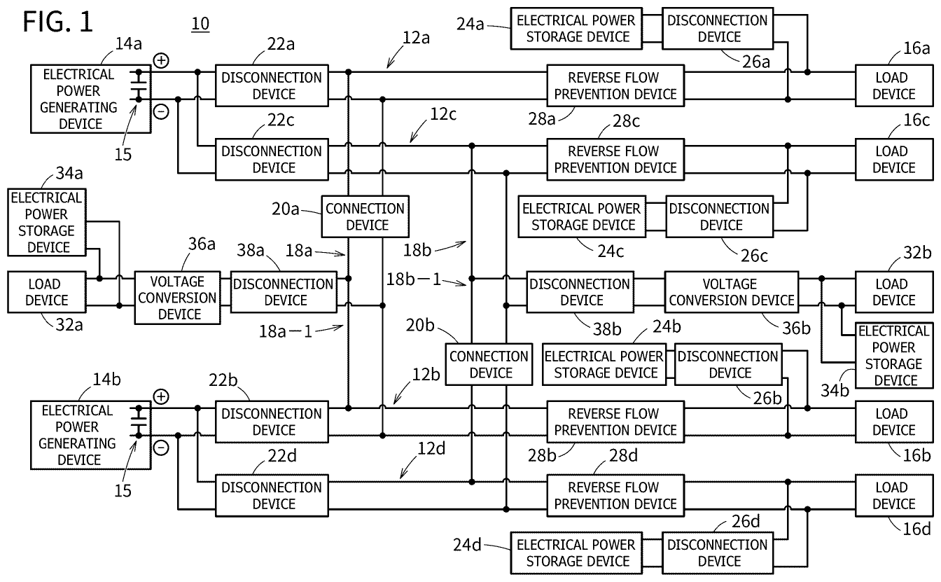

FIG. 1 is a schematic diagram of an electrical power supply system 10 according to a first embodiment. The electrical power supply system 10 is equipped with an electrical power supply circuit (a third electrical power supply circuit) 12a, an electrical power supply circuit (a fourth electrical power supply circuit) 12b, an electrical power supply circuit (a first electrical power supply circuit) 12c, and an electrical power supply circuit (a second electrical power supply circuit) 12d. The electrical power supply circuit 12a supplies a DC electrical power output from an electrical power generating device (a first electrical power generating device) 14a, to a load device (a third load device) 16a. The electrical power supply circuit 12b supplies a DC electrical power output from an electrical power generating device (a second electrical power generating device) 14b, to a load device (a fourth load device) 16b. The electrical power supply circuit 12c supplies the DC electrical power output from the electrical power generating device 14a, to a load device (a first load device) 16c. The electrical power supply circuit 12d supplies the DC electrical power output from the electrical power generating device 14b, to a load device (a second load device) 16d.

The electrical power generating device 14a and the electrical power generating device 14b each include an engine, an electrical power generator, and a power control unit, none of which is shown. The electrical power generator is driven by the engine, and the electrical power generator thereby generates a three-phase AC electrical power. The power control unit converts the three-phase AC electrical power into a DC electrical power. The electrical power generating device 14a and the electrical power generating device 14b each include a capacitor 15. In the case that the electrical power generating device 14a and the electrical power generating device 14b are started, it is necessary that the capacitors 15 be charged in advance.

The electrical power generating device 14a and the electrical power generating device 14b may also include various sensors such as voltage sensors and electrical current sensors, and various elements such as fuses, relays, breakers, diodes, transistors, resistors, coils, capacitors, and the like.

The load device 16a, the load device 16b, the load device 16c, and the load device 16d each include an inverter and an electric motor, neither of which is shown. The inverter converts an input DC electrical power into a three-phase AC electrical power. The electric motor is driven by the three-phase AC electrical power. The rated voltage of the load device 16a, the load device 16b, the load device 16c, and the load device 16d is a high voltage of several hundred volts. The load device 16a, the load device 16b, the load device 16c, and the load device 16d are main devices.

The load device 16a, the load device 16b, the load device 16c, and the load device 16d may also include various sensors such as voltage sensors and electrical current sensors, and various elements such as fuses, relays, breakers, diodes, transistors, resistors, coils, capacitors, and the like.

The electrical power supply system 10 is equipped with a connection circuit (a second connection circuit) 18a and a connection circuit (a first connection circuit) 18b. The connection circuit 18a is equipped with a connection device (a second connection device) 20a that is capable of connecting the electrical power supply circuit 12a and the electrical power supply circuit 12b. The connection circuit 18b is equipped with a connection device (a first connection device) 20b that is capable of connecting the electrical power supply circuit 12c and the electrical power supply circuit 12d.

The connection device 20a and the connection device 20b each include positive and negative switches. The switches may be constituted by relays or contactors. The connection device 20a and the connection device 20b may each include a breaker.

Normally, the connection between the electrical power supply circuit 12a and the electrical power supply circuit 12b is disconnected. In accordance with this feature, in the case that an electrical abnormality has occurred in one of the electrical power supply circuit 12a or the electrical power supply circuit 12b, it is possible to prevent an influence of the abnormality from adversely affecting the other of the electrical power supply circuit 12a and the electrical power supply circuit 12b. For example, in the case that an excessive current has occurred in one of the electrical power supply circuit 12a or the electrical power supply circuit 12b, it is possible to prevent the excessive current from flowing to the other of the electrical power supply circuit 12a and the electrical power supply circuit 12b.

In the same manner, normally, the connection between the electrical power supply circuit 12c and the electrical power supply circuit 12d is disconnected. In accordance with this feature, in the case that an electrical abnormality has occurred in one of the electrical power supply circuit 12c or the electrical power supply circuit 12d, it is possible to prevent an influence of the abnormality from adversely affecting the other of the electrical power supply circuit 12c and the electrical power supply circuit 12d. For example, in the case that an excessive current has occurred in one of the electrical power supply circuit 12c or the electrical power supply circuit 12d, it is possible to prevent the excessive current from flowing to the other of the electrical power supply circuit 12c and the electrical power supply circuit 12d.

In the case that the supply of the electrical power from the electrical power generating device 14a to the electrical power supply circuit 12a and the electrical power supply circuit 12c is cut off, the electrical power supply circuit 12a and the electrical power supply circuit 12b are connected by the connection device 20a. Further, the electrical power supply circuit 12c and the electrical power supply circuit 12d are connected by the connection device 20b. In accordance with this feature, the electrical power is supplied from the electrical power generating device 14b to the electrical power supply circuit 12a and the electrical power supply circuit 12c.

In the case that the supply of the electrical power from the electrical power generating device 14b to the electrical power supply circuit 12b and the electrical power supply circuit 12d is cut off, the electrical power supply circuit 12a and the electrical power supply circuit 12b are connected by the connection device 20a. Further, the electrical power supply circuit 12c and the electrical power supply circuit 12d are connected by the connection device 20b. In accordance with this feature, the electrical power is supplied from the electrical power generating device 14a to the electrical power supply circuit 12b and the electrical power supply circuit 12d.

The electrical power supply system 10 includes a disconnection device 22a, a disconnection device 22b, a disconnection device 22c, and a disconnection device 22d. The disconnection device 22a is capable of disconnecting the electrical power generating device 14a from the electrical power supply circuit 12a and the connection circuit 18a. The disconnection device 22b is capable of disconnecting the electrical power generating device 14b from the electrical power supply circuit 12b and the connection circuit 18a. The disconnection device 22c is capable of disconnecting the electrical power generating device 14a from the electrical power supply circuit 12c and the connection circuit 18b. The disconnection device 22d is capable of disconnecting the electrical power generating device 14b from the electrical power supply circuit 12d and the connection circuit 18b.

The disconnection device 22a, the disconnection device 22b, the disconnection device 22c, and the disconnection device 22d each include positive and negative switches. The switches may be constituted by relays or contactors. The disconnection device 22a, the disconnection device 22b, the disconnection device 22c, and the disconnection device 22d may each include a breaker.

The electrical power supply system 10 is equipped with an electrical power storage device 24a, an electrical power storage device (a third electrical power storage device) 24b, an electrical power storage device (a first electrical power storage device) 24c, and an electrical power storage device 24d. The electrical power storage device 24a is connected, in parallel with the electrical power generating device 14a, to the electrical power supply circuit 12a. The electrical power storage device 24b is connected, in parallel with the electrical power generating device 14b, to the electrical power supply circuit 12b. The electrical power storage device 24c is connected, in parallel with the electrical power generating device 14a, to the electrical power supply circuit 12c. The electrical power storage device 24d is connected, in parallel with the electrical power generating device 14b, to the electrical power supply circuit 12d.

The electrical power storage device 24a, the electrical power storage device 24b, the electrical power storage device 24c, and the electrical power storage device 24d each includes a lithium ion battery. The electrical power storage device 24a, the electrical power storage device 24b, the electrical power storage device 24c, and the electrical power storage device 24d may each include a secondary battery other than a lithium ion battery. The electrical power storage device 24a, the electrical power storage device 24b, the electrical power storage device 24c, and the electrical power storage device 24d may each include a large-capacity capacitor. The rated output voltage of the electrical power storage device 24a, the electrical power storage device 24b, the electrical power storage device 24c, and the electrical power storage device 24d is a high voltage of several hundred volts.

The electrical power storage device 24a, the electrical power storage device 24b, the electrical power storage device 24c, and the electrical power storage device 24d may include various sensors such as voltage sensors, electrical current sensors, and the like. The electrical power storage device 24a, the electrical power storage device 24b, the electrical power storage device 24c, and the electrical power storage device 24d may include various elements such as fuses, relays, breakers, diodes, transistors, resistors, coils, capacitors, and the like.

The electrical power supply system 10 is equipped with a disconnection device 26a, a disconnection device 26b, a disconnection device 26c, and a disconnection device 26d. The disconnection device 26a is capable of disconnecting the electrical power storage device 24a from the electrical power supply circuit 12a and the load device 16a. The disconnection device 26b is capable of disconnecting the electrical power storage device 24b from the electrical power supply circuit 12b and the load device 16b. The disconnection device 26c is capable of disconnecting the electrical power storage device 24c from the electrical power supply circuit 12c and the load device 16c. The disconnection device 26d is capable of disconnecting the electrical power storage device 24d from the electrical power supply circuit 12d and the load device 16d.

The disconnection device 26a, the disconnection device 26b, the disconnection device 26c, and the disconnection device 26d each include positive and negative switches. The switches may be constituted by relays or contactors. The disconnection device 26a, the disconnection device 26b, the disconnection device 26c, and the disconnection device 26d may each include a breaker.

The electrical power supply system 10 is equipped with a reverse flow prevention device 28a, a reverse flow prevention device 28b, a reverse flow prevention device 28c, and a reverse flow prevention device 28d. The reverse flow prevention device 28a is provided in the electrical power supply circuit 12a. The reverse flow prevention device 28a limits the supply of the electrical power from the load device 16a and the electrical power storage device 24a to the electrical power generating device 14a. The reverse flow prevention device 28b is provided in the electrical power supply circuit 12b. The reverse flow prevention device 28b limits the supply of the electrical power from the load device 16b and the electrical power storage device 24b to the electrical power generating device 14b. The reverse flow prevention device 28c is provided in the electrical power supply circuit 12c. The reverse flow prevention device 28c limits the supply of the electrical power from the load device 16c and the electrical power storage device 24c to the electrical power generating device 14a. The reverse flow prevention device 28d is provided in the electrical power supply circuit 12d. The reverse flow prevention device 28d limits the supply of the electrical power from the load device 16d and the electrical power storage device 24d to the electrical power generating device 14b.

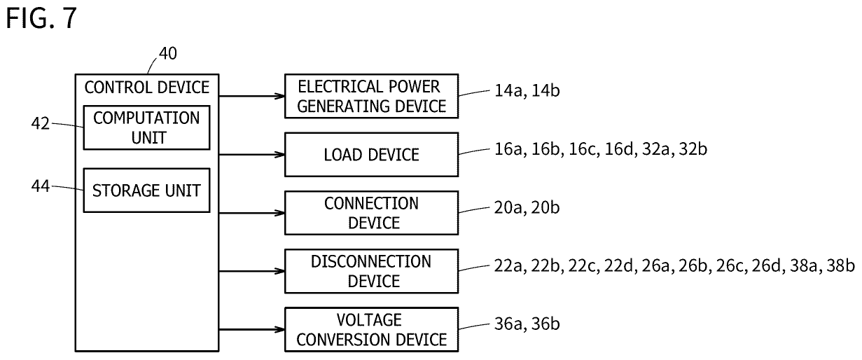

The reverse flow prevention device 28a includes a diode and a transistor. The diode and the transistor are provided in a positive wire (or a negative wire). The transistor is provided to bypass the diode. The diode allows an electrical current to flow from the electrical power generating device 14a to the load device 16a and the electrical power storage device 24a. By an ON signal being supplied from a control device 40 (FIG. 7), the transistor makes it possible for an electrical current to flow from the load device 16a and the electrical power storage device 24a to the electrical power generating device 14a. The configurations of the reverse flow prevention device 28b, the reverse flow prevention device 28c, and the reverse flow prevention device 28d are the same as the configuration of the reverse flow prevention device 28a.

The electrical power supply system 10 is equipped with a load device 32a and a load device 32b. The load device 32a is connected, in parallel with the electrical power generating device 14b, to a partial circuit 18a-1 within the connection circuit 18a. The partial circuit 18a-1 is positioned between the connection device 20a and the electrical power supply circuit 12b. The load device 32b is connected, in parallel with the electrical power generating device 14a, to a partial circuit 18b-1 within the connection circuit 18b. The partial circuit 18b-1 is positioned between the connection device 20b and the electrical power supply circuit 12c. The rated voltage of the load device 32b is a low voltage of several tens of volts. The load device 32b is an auxiliary device.

The electrical power supply system 10 is equipped with an electrical power storage device (a fourth electrical power storage device) 34a, and an electrical power storage device (a second electrical power storage device) 34b. The electrical power storage device 34a is connected, in parallel with the electrical power generating device 14b, to the partial circuit 18a-1. The electrical power storage device 34a is connected, in parallel with the load device 32a, to the partial circuit 18a-1. The electrical power storage device 34a is capable of supplying the electrical power to the load device 32a. The electrical power storage device 34b is connected, in parallel with the electrical power generating device 14a, to the partial circuit 18b-1. The electrical power storage device 34b is connected, in parallel with the load device 32b, to the partial circuit 18b-1. The electrical power storage device 34b is capable of supplying the electrical power to the load device 32b.

The electrical power storage device 34a and the electrical power storage device 34b each include a lithium ion battery. The electrical power storage device 34b may include a secondary battery other than a lithium ion battery. The electrical power storage device 34b may include a small-capacity capacitor. The rated output voltage of the electrical power storage device 34a and the electrical power storage device 34b is a low voltage of several tens of volts.

The electrical power supply system 10 is equipped with a voltage conversion device 36a. The voltage conversion device 36a is provided at a location which is between the load device 32a and the partial circuit 18a-1, and is between the electrical power storage device 34a and the partial circuit 18a-1. The voltage conversion device 36a is capable of stepping down the electrical power supplied from the electrical power generating device 14b, and then supplying the stepped down electrical power to the load device 32a and the electrical power storage device 34a. Further, the voltage conversion device 36a is capable of stepping up the electrical power supplied from the electrical power storage device 34a, and then supplying the stepped up electrical power to the electrical power generating device 14b.

The electrical power supply system 10 is equipped with a voltage conversion device 36b. The voltage conversion device 36b is provided at a location which is between the load device 32b and the partial circuit 18b-1, and is between the electrical power storage device 34b and the partial circuit 18b-1. The voltage conversion device 36b is capable of stepping down the electrical power supplied from the electrical power generating device 14a, and then supplying the stepped down electrical power to the load device 32b and the electrical power storage device 34b. Further, the voltage conversion device 36b is capable of stepping up the electrical power supplied from the electrical power storage device 34b, and then supplying the stepped up electrical power to the electrical power generating device 14a.

The voltage conversion device 36a and the voltage conversion device 36b each include, for example, a DC/DC converter. An output voltage of the DC/DC converter is adjusted by adjusting a duty ratio of the DC/DC converter.

The electrical power supply system 10 is equipped with a disconnection device 38a. The disconnection device 38a is provided between the voltage conversion device 36a and the partial circuit 18a-1. The disconnection device 38a is capable of disconnecting the load device 32a, the electrical power storage device 34a, and the voltage conversion device 36a from the partial circuit 18a-1.

The electrical power supply system 10 is equipped with a disconnection device 38b. The disconnection device 38b is provided between the voltage conversion device 36b and the partial circuit 18b-1. The disconnection device 38b is capable of disconnecting the load device 32b, the electrical power storage device 34b, and the voltage conversion device 36b from the partial circuit 18b-1.

The disconnection device 38a and the disconnection device 38b each include positive and negative switches. The switches may be constituted by relays or contactors. The disconnection device 38a and the disconnection device 38b may each include a breaker.

### [Configuration of Electrical Power Supply System in Second Embodiment]

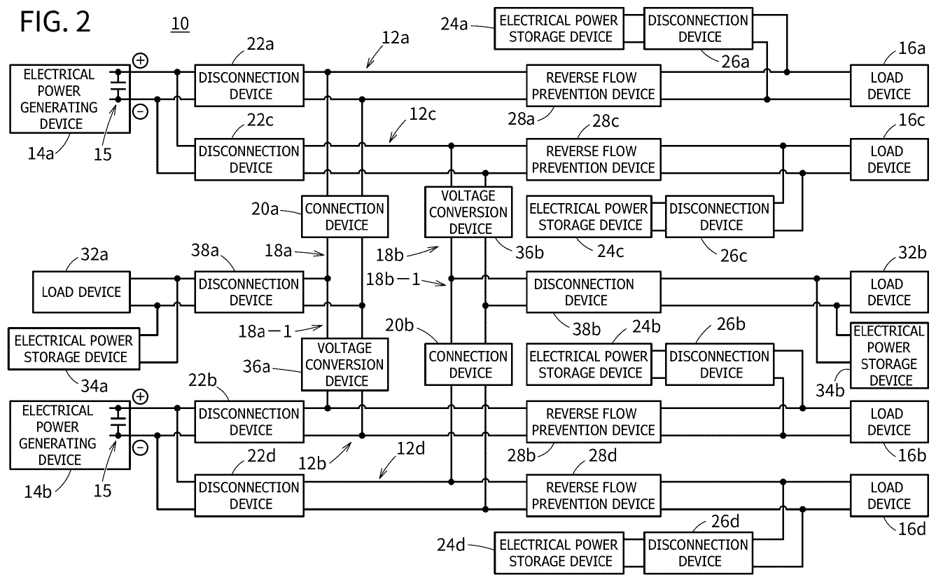

FIG. 2 is a schematic diagram of an electrical power supply system 10 according to a second embodiment. Concerning the second embodiment, descriptions concerning constituent parts thereof that are common to the first embodiment will be omitted, and only constituent parts that differ from those of the first embodiment will be described. The electrical power supply system 10 according to the second embodiment differs from the electrical power supply system 10 according to the first embodiment in the arrangement of the voltage conversion device 36a and the voltage conversion device 36b.

The voltage conversion device 36a is provided in the partial circuit 18a-1 within the connection circuit 18a. The load device 32a and the electrical power storage device 34a are connected, in parallel with the electrical power generating device 14b, to a portion of the partial circuit 18a-1 positioned between the connection device 20a and the voltage conversion device 36a.

The voltage conversion device 36b is provided in the partial circuit 18b-1 within the connection circuit 18b. The load device 32b and the electrical power storage device 34b are connected, in parallel with the electrical power generating device 14a, to a portion of the partial circuit 18b-1 positioned between the connection device 20b and the voltage conversion device 36b.

### [Operations of Electrical Power Supply System at Normal Time]

The operations of the electrical power supply system 10 in the first embodiment are substantially the same as the operations of the electrical power supply system 10 in the second embodiment. Hereinafter, the operations of the electrical power supply system 10 at a normal time will be described using the circuit of the second embodiment.

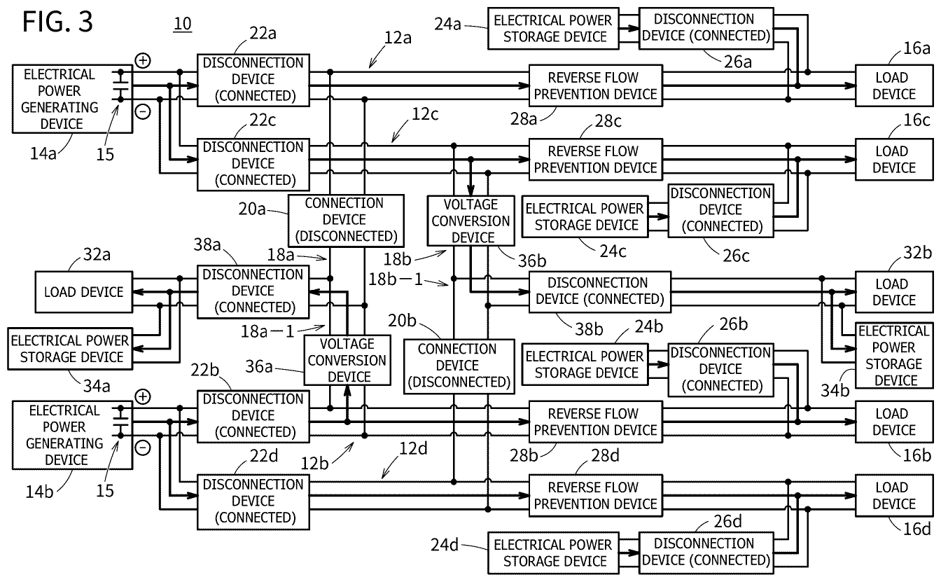

FIG. 3 is a diagram showing operations of the electrical power supply system 10 at a normal time. The arrows shown in FIG. 3 indicate electrical power supply pathways.

As shown in FIG. 3, the connection between the electrical power supply circuit 12a and the electrical power supply circuit 12b is disconnected by the connection device 20a. The connection between the electrical power supply circuit 12c and the electrical power supply circuit 12d is disconnected by the connection device 20b.

The electrical power generating device 14a is connected by the disconnection device 22a to the electrical power supply circuit 12a and the connection circuit 18a. The electrical power generating device 14a is connected by the disconnection device 22c to the electrical power supply circuit 12c and the connection circuit 18b. In accordance with this feature, the electrical power is supplied from the electrical power generating device 14a to the load device 16a and the load device 16c.

The electrical power storage device 24a is connected by the disconnection device 26a to the load device 16a. In accordance with this feature, the electrical power is supplied from the electrical power storage device 24a to the load device 16a. The electrical power storage device 24c is connected by the disconnection device 26c to the load device 16c. In accordance with this feature, the electrical power is supplied from the electrical power storage device 24c to the load device 16c. The electrical power generating device 14b is connected by the disconnection device 22b to the electrical power supply circuit 12b and the connection circuit 18a. The electrical power generating device 14b is connected by the disconnection device 22d to the electrical power supply circuit 12d and the connection circuit 18b. In accordance with this feature, the electrical power is supplied from the electrical power generating device 14b to the load device 16b and the load device 16d.

The electrical power storage device 24b is connected by the disconnection device 26b to the load device 16b. In accordance with this feature, the electrical power is supplied from the electrical power storage device 24b to the load device 16b. The electrical power storage device 24d is connected by the disconnection device 26d to the load device 16d. In accordance with this feature, the electrical power is supplied from the electrical power storage device 24d to the load device 16d.

The load device 32a and the electrical power storage device 34a are connected by the disconnection device 38a to the partial circuit 18a-1 within the connection circuit 18a. In accordance with this feature, the electrical power is supplied from the electrical power generating device 14b to the load device 32a and the electrical power storage device 34a. The voltage conversion device 36a steps down the electrical power supplied from the electrical power generating device 14b, and then supplies the stepped down electrical power to the load device 32a and the electrical power storage device 34a.

The load device 32b and the electrical power storage device 34b are connected by the disconnection device 38b to the partial circuit 18b-1 within the connection circuit 18b. In accordance with this feature, the electrical power is supplied from the electrical power generating device 14a to the load device 32b and the electrical power storage device 34b. The voltage conversion device 36b steps down the electrical power supplied from the electrical power generating device 14a, and then supplies the stepped down electrical power to the load device 32b and the electrical power storage device 34b.

### [Operations of Electrical Power Supply System at Time of First Abnormality]

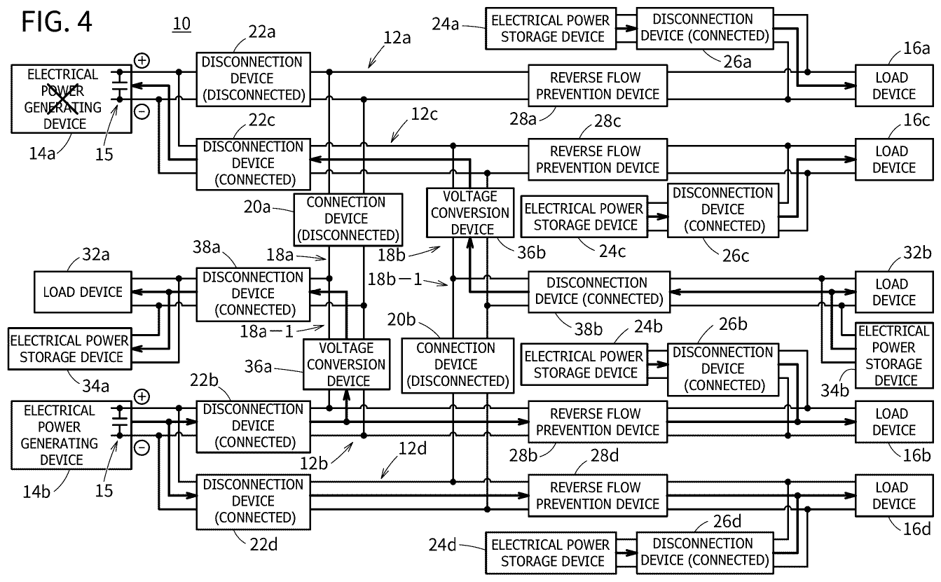

FIG. 4 is a diagram showing operations of the electrical power supply system 10 at a time of a first abnormality. The arrows shown in FIG. 4 indicate electrical power supply pathways.

The first abnormality refers to an abnormality in which the electrical power generating device 14a (or the electrical power generating device 14b), which has been stopped, is capable of being restarted. There may be a case in which some trouble occurs during the operation of the electrical power supply system 10, and the engine provided in the electrical power generating device 14a is stopped. In the case that the electrical power generating device 14a is capable of being restarted, the electrical power is supplied to the electrical power generator provided in the electrical power generating device 14a, and restarting of the engine is carried out. In accordance with this feature, the electrical power generating device 14a which has been stopped is restarted. Hereinafter, a description will be given of the operation of the electrical power supply system 10 from the electrical power generating device 14a being stopped until the electrical power generating device 14a is restarted.

For example, in the case that the electrical power generating device 14a is stopped, the supply of the electrical power from the electrical power generating device 14a to the electrical power supply circuit 12a and the electrical power supply circuit 12c is cut off. In this case, as shown in FIG. 4, the electrical power generating device 14a is disconnected from the electrical power supply circuit 12a and the connection circuit 18a by the disconnection device 22a. On the other hand, the electrical power generating device 14a is connected by the disconnection device 22c to the electrical power supply circuit 12c and the connection circuit 18b.

The electrical power storage device 34b is connected by the disconnection device 38b to the partial circuit 18b-1 within the connection circuit 18b. In accordance with this feature, the electrical power generating device 14a and the electrical power storage device 34b are connected. Accordingly, the electrical power is supplied from the electrical power storage device 34b to the electrical power generating device 14a which is stopped. The voltage conversion device 36b steps up the electrical power supplied from the electrical power storage device 34b, and then supplies the stepped up electrical power to the electrical power generating device 14a. At this time, the control device 40 of the electrical power supply system 10, by gradually increasing the duty ratio of the voltage conversion device 36b, can thereby gradually step up the electrical power supplied to the electrical power generating device 14a.

By supplying the electrical power to the electrical power generating device 14a, the capacitor 15 provided in the electrical power generating device 14a is charged. The electrical power generator provided in the electrical power generating device 14a is powered by being supplied with the electrical power, and thereby causes the engine provided in the electrical power generating device 14a to be restarted.

The electrical power supply pathway from the electrical power generating device 14b to the load device 16b, the load device 16d, the load device 32a, and the electrical power storage device 34a is the same as at the normal time (FIG. 3). Further, the electrical power supply pathway from the electrical power storage device 24a to the load device 16a is the same as at the normal time. Similarly, the electrical power supply pathway from each of the electrical power storage device 24b, the electrical power storage device 24c, and the electrical power storage device 24d to each of the load device 16b, the load device 16c, and the load device 16d is the same as at the normal time.

### [Operations of Electrical Power Supply System at Time of Second Abnormality]

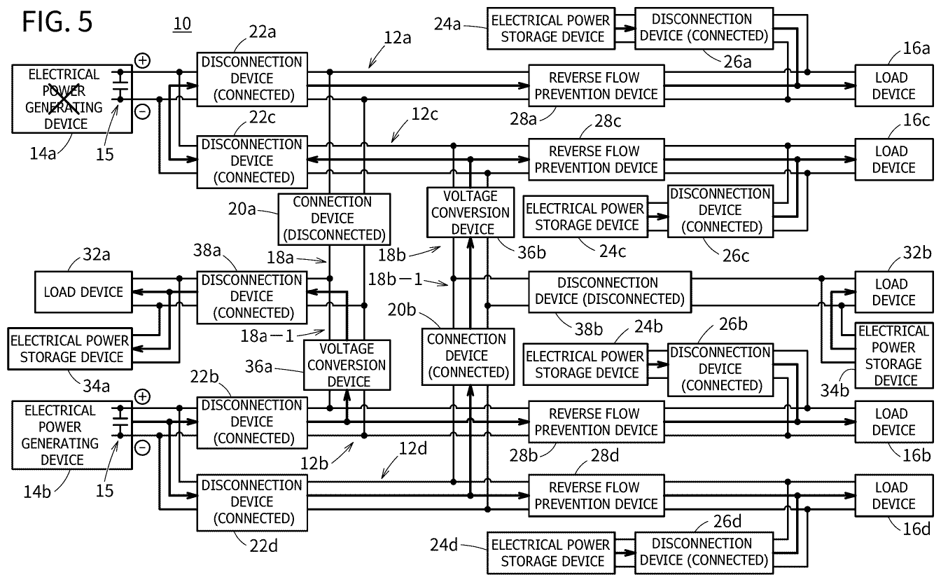

FIG. 5 is a diagram showing operations of the electrical power supply system 10 at a time of a second abnormality. The arrows shown in FIG. 5 indicate electrical power supply pathways.

The second abnormality refers to an abnormality in which the electrical power generating device 14a (or the electrical power generating device 14b), which has been stopped, is incapable of being restarted. In the case that the electrical power generating device 14a is incapable of being restarted, a control for restarting the electrical power generating device 14a is not executed. In this case, the load device 16a and the load device 16c are supplied with the electrical power from the electrical power generating device 14b. Hereinafter, a description will be given of the operation of the electrical power supply system 10 from the electrical power generating device 14a being stopped until the electrical power generating device 14b starts supplying the electrical power to the load device 16a and the load device 16c.

For example, in the case that the electrical power generating device 14a is stopped, the supply of the electrical power from the electrical power generating device 14a to the electrical power supply circuit 12a and the electrical power supply circuit 12c is cut off. In this case, the control device 40 of the electrical power supply system 10, as shown in FIG. 5, executes a connection control of the connection device 20b. In accordance with this feature, the electrical power supply circuit 12c and the electrical power supply circuit 12d are connected by the connection device 20b. Furthermore, the electrical power supply circuit 12a and the electrical power supply circuit 12c are connected by the disconnection device 22a and the disconnection device 22c. Therefore, together with the electrical power being supplied from the electrical power generating device 14b to the electrical power supply circuit 12c, the electrical power is supplied from the electrical power generating device 14b to the electrical power supply circuit 12a.

Moreover, it should be noted that, prior to the electrical power supply circuit 12c and the electrical power supply circuit 12d being connected, a potential difference may occur between the electrical power supply circuit 12c and the electrical power supply circuit 12d. When the electrical power supply circuit 12c and the electrical power supply circuit 12d are connected in a state in which the potential difference is large, there is a concern that an inrush current from the circuit having a higher potential to the circuit having a lower potential may occur. At this time, the control device 40 is capable of suppressing the occurrence of such an inrush current by gradually increasing the duty ratio of the voltage conversion device 36b.

The load device 32b and the electrical power storage device 34b are disconnected by the disconnection device 38b from the partial circuit 18b-1 within the connection circuit 18b. The electrical power is supplied to the load device 32b from the electrical power storage device 34b.

The electrical power supply pathway from the electrical power generating device 14b to the load device 16b, the load device 16d, the load device 32a, and the electrical power storage device 34a is the same as at the normal time (FIG. 3). Further, the electrical power supply pathway from the electrical power storage device 24a to the load device 16a is the same as at the normal time. Similarly, the electrical power supply pathway from each of the electrical power storage device 24b, the electrical power storage device 24c, and the electrical power storage device 24d to each of the load device 16b, the load device 16c, and the load device 16d is the same as at the normal time.

### [Configuration of Electrical Power Supply System in Third Embodiment]

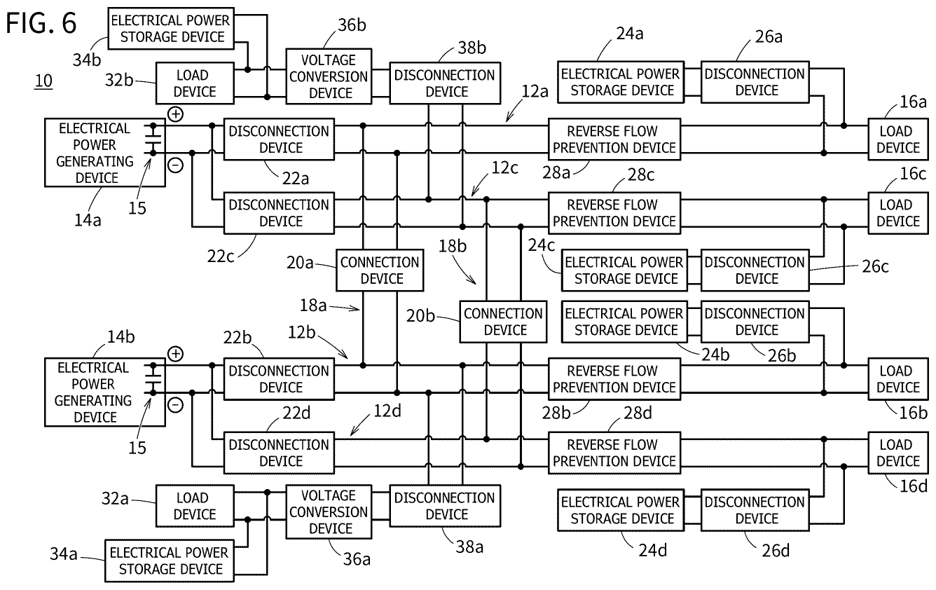

FIG. 6 is a schematic diagram of an electrical power supply system 10 according to a third embodiment. The load device 32a, the electrical power storage device 34a, the voltage conversion device 36a, and the disconnection device 38a may be connected to portions other than the connection circuit 18a. The load device 32a, the electrical power storage device 34a, the voltage conversion device 36a, and the disconnection device 38a may be connected, in parallel with the electrical power generating device 14b, to a circuit between the electrical power generating device 14b and the reverse flow prevention device 28b in the electrical power supply circuit 12b.

Similarly, the load device 32b, the electrical power storage device 34b, the voltage conversion device 36b, and the disconnection device 38b may be connected to portions other than the connection circuit 18b. The load device 32b, the electrical power storage device 34b, the voltage conversion device 36b, and the disconnection device 38b may be connected, in parallel with the electrical power generating device 14a, to a circuit between the electrical power generating device 14a and the reverse flow prevention device 28c in the electrical power supply circuit 12c.

### [Configuration of Control Device]

FIG. 7 is a control block diagram of the control device 40 according to the first embodiment to the third embodiment. The electrical power supply system 10 is equipped with the control device 40.

The control device 40 includes a computation unit 42 and a storage unit 44. The computation unit 42 includes a processor such as a CPU (Central Processing Unit) or a GPU (Graphics Processing Unit) or the like. The computation unit 42 controls each of devices by executing a program that is stored in the storage unit 44. At least a portion of the computation unit 42 may be realized by an integrated circuit such as an ASIC (Application Specific Integrated Circuit) or an FPGA (Field-Programmable Gate Array) or the like. At least a portion of the computation unit 42 may be realized by an electronic circuit including a discrete device.

The storage unit 44 is constituted by a volatile memory and a non-volatile memory, which are computer readable storage media. The volatile memory, for example, is a RAM (Random Access Memory) or the like. The non-volatile memory, for example, is a ROM (Read Only Memory), a flash memory, or the like. Data and the like are stored, for example, in the volatile memory. A program, a table, a map and the like are stored, for example, in the non-volatile memory. At least a portion of the storage unit 44 may be provided in the processor, the integrated circuit, or the like described above.

The control device 40 controls each of the electrical power generating device 14a, the electrical power generating device 14b, the load device 16a, the load device 16b, the load device 16c, the load device 16d, the load device 32a, the load device 32b, the connection device 20a, the connection device 20b, the disconnection device 22a, the disconnection device 22b, the disconnection device 22c, the disconnection device 22d, the disconnection device 26a, the disconnection device 26b, the disconnection device 26c, the disconnection device 26d, the disconnection device 38a, the disconnection device 38b, the voltage conversion device 36a, and the voltage conversion device 36b. A distributed control may be carried out by a plurality of the control devices 40.

### [Advantageous Effects of Respective Embodiments]

As discussed previously, if some trouble occurs during the operation of the electrical power supply system 10, the engine provided in the electrical power generating device 14a may be stopped. If the degree of the trouble is minor, it is frequently the case that it is possible to restart the electrical power generating device 14a. Concerning a method of restarting the electrical power generating device 14a, several possible methods may be considered.

For example, in a first method for restarting the electrical power generating device 14a, it may be considered to supply the electrical power from the electrical power generating device 14b to the electrical power generating device 14a. In this case, for example, a connection control of the connection device 20a is executed. In accordance with this feature, the electrical power supply circuit 12a and the electrical power supply circuit 12b are connected, and it becomes possible for the electrical power to be supplied from the electrical power generating device 14b to the electrical power generating device 14a.

The connection device 20a, normally, is in a disconnected state, in a manner so that an abnormality occurring in one of the electrical power supply circuit 12a or the electrical power supply circuit 12b does not have an adverse influence on the other. In accordance with this feature, it is possible to improve the toughness of the electrical power supply system 10 with respect to failures in the electrical power supply circuits 12a and 12b. However, if the connection control of the connection device 20a is executed every time that the electrical power generating device 14a is stopped, the toughness of the electrical power supply system 10 decreases in the case that the frequency at which the electrical power generating device 14a is stopped is comparatively high.

Further, at a time when the electrical power supply circuit 12a and the electrical power supply circuit 12b are switched by the connection device 20a from the connected state to the disconnected state, an arc is generated in the connection device 20a. Therefore, it is necessary to use the connection device 20a having a high toughness with respect to such an arc. However, the weight of the connection device 20a having a high toughness with respect to such an arc is heavy.

For the foregoing reasons, it is not preferable to execute the connection control of the connection device 20a every time that the electrical power generating device 14a is restarted. The same also applies to the connection device 20b.

For example, in a second method for restarting the electrical power generating device 14a, it may be considered to supply the electrical power from the electrical power storage device 24a to the electrical power generating device 14a. In this case, a signal is supplied in order to place the transistor provided in the reverse flow prevention device 28a in an ON state. In accordance with this feature, the electrical power is supplied from the electrical power storage device 24a to the electrical power generating device 14a.

However, when the electrical power is supplied from the electrical power storage device 24a to the electrical power generating device 14a, the electrical power that can be supplied from the electrical power storage device 24a to the load device 16a decreases. Upon doing so, there is a concern that the required electrical power needed for the operation of the load device 16a will not be satisfied, and along therewith, there is a concern that an adverse influence on the operation of the load device 16a, which is a main device, will occur.

For the foregoing reasons, it is not preferable to use the electrical power storage device 24a in order to restart the electrical power generating device 14a. The same also applies to the electrical power storage device 24c.

On the other hand, in each of the above-described embodiments, when the electrical power generating device 14a is restarted, the electrical power is supplied from the electrical power storage device 34b to the electrical power generating device 14a. In other words, in each of the above-described embodiments, since it is not necessary to execute the connection control of the connection device 20a in order to restart the electrical power generating device 14a that has been stopped, the aforementioned problem does not occur. More specifically, a reduction in the toughness of the electrical power supply system 10 with respect to a failure of the electrical power supply circuits 12a and 12b is not brought about, and it is not necessary to use the connection device 20a, which although having a high arc toughness, is heavy. Further, in each of the above-described embodiments, since it is unnecessary to supply the electrical power from the electrical power storage device 24a to the electrical power generating device 14a in order to restart the electrical power generating device 14a, an adverse influence on the operation of the load device 16a does not occur due to the restarting of the electrical power generating device 14a.

Further, according to the second embodiment, the following advantageous effects can be obtained. In the case that the second abnormality has occurred, the control device 40 executes the connection control of the connection device 20a and the connection device 20b. When executing the connection control of the connection device 20a, the control device 40 may gradually increase the duty ratio of the voltage conversion device 36a. In accordance with this feature, it is possible to suppress the occurrence of an inrush current from one of the electrical power supply circuit 12a or the electrical power supply circuit 12b to the other. Similarly, when executing the connection control of the connection device 20b, the control device 40 may gradually increase the duty ratio of the voltage conversion device 36b. In accordance with this feature, it is possible to suppress the occurrence of an inrush current from one of the electrical power supply circuit 12c or the electrical power supply circuit 12d to the other.

### [Configuration of Moving Object]

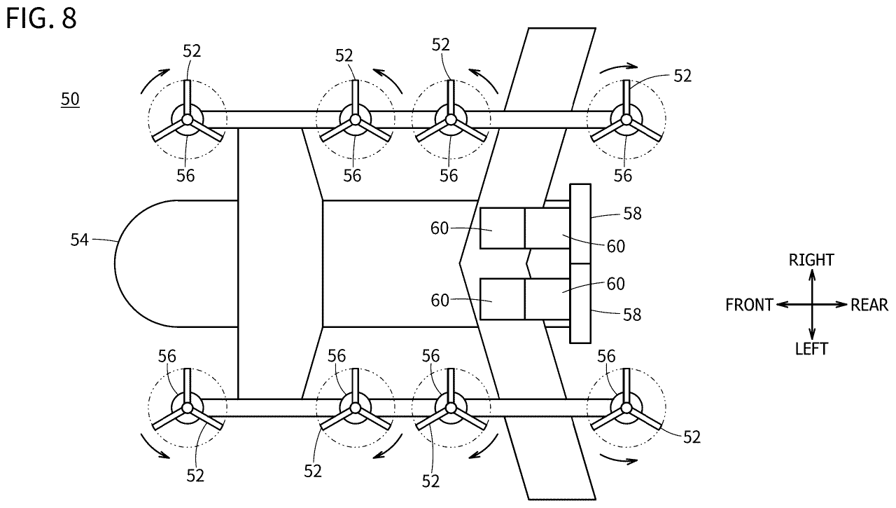

FIG. 8 is a schematic diagram of a moving object 50. The electrical power supply system 10 is mounted in the moving object 50.

The moving object 50 of the present embodiment, for example, is an electric vertical take-off and landing aircraft (eVTOL aircraft). The moving object 50 is equipped with eight VTOL rotors 52. The VTOL rotors 52 generate an upwardly directed thrust with respect to a fuselage 54. The moving object 50 is equipped with eight electric motors 56. One of the electric motors 56 drives one of the VTOL rotors 52. The moving object 50 includes two cruise rotors 58. The cruise rotors 58 generate a forwardly directed thrust with respect to the fuselage 54. The moving object 50 is equipped with four electric motors 60. Two of the electric motors 60 drive one of the cruise rotors 58.

Each of the load device 16a, the load device 16b, the load device 16c, and the load device 16d may be equipped with two of the electric motors 56 and one of the electric motors 60, respectively. Each of the load device 32a and the load device 32b may include a non-illustrated low-voltage drive device (an air conditioner, avionics, or the like) inside the fuselage 54.

The moving object 50 is not limited to being an aircraft, but may be a ship, an automobile, a train, or the like.

In relation to the above-described embodiments, the following supplementary notes are further disclosed.

### Supplementary Note 1

The electrical power supply system (10) according to the present disclosure includes the first electrical power supply circuit (12c) that supplies, to the first load device (16c), the DC electrical power output from the first electrical power generating device (14a), the second electrical power supply circuit (12d) that supplies, to the second load device (16d), the DC electrical power output from the second electrical power generating device (14b), the first connection circuit (18b) equipped with the first connection device (20b) that is capable of connecting the first electrical power supply circuit and the second electrical power supply circuit, the first electrical power storage device (24c) connected, in parallel with the first electrical power generating device, to the first electrical power supply circuit, and the second electrical power storage device (34b) connected, in parallel with the first electrical power generating device, to the first connection circuit, the second electrical power storage device having the rated output voltage lower than the rated output voltage of the first electrical power storage device.

According to the above-described configuration, in the case that the first electrical power generating device is stopped, the first electrical power generating device can be restarted by supplying an electrical power from the second electrical power storage device to the first electrical power generating device. Furthermore, according to the above-described configuration, the first electrical power generating unit can be restarted satisfactorily without reducing the toughness of the electrical power supply system with respect to a failure in the electrical power supply circuit, and without the need to use a connection device, which although having a high arc toughness, is heavy. Therefore, in accordance with such a configuration, it is possible to provide a more satisfactory electrical power supply system.

### Supplementary Note 2

The electrical power supply system according to Supplementary Note 1 may further include the reverse flow prevention device (28c) that is provided in the first electrical power supply circuit, and limits the supply of the electrical power from the first electrical power storage device to the first electrical power generating device, wherein the first connection circuit may be connected to a portion of the first electrical power supply circuit that is positioned between the first electrical power generating device and the reverse flow prevention device.

### Supplementary Note 3

The electrical power supply system according to Supplementary Note 1 may further include the disconnection device (38b) that is capable of disconnecting the second electrical power storage device from the first connection circuit.

### Supplementary Note 4

The electrical power supply system according to Supplementary Note 1 may further include the voltage conversion device (36b) which is capable of stepping down the electrical power supplied from the first electrical power generating device and supplying the stepped down electrical power to the second electrical power storage device, and is capable of stepping up the electrical power supplied from the second electrical power storage device and supplying the stepped up electrical power to the first electrical power generating device.

### Supplementary Note 5

In the electrical power supply system according to Supplementary Note 4, the voltage conversion device may be provided in the first connection circuit.

In accordance with the above-described configuration, it is possible to suppress the occurrence of an inrush current from one of the first electrical power supply circuit or the second electrical power supply circuit to the other.

### Supplementary Note 6

The electrical power supply system according to Supplementary Note 1 may further include the third electrical power supply circuit (12a) that supplies, to the third load device (16a), the DC electrical power output from the first electrical power generating device, the fourth electrical power supply circuit (12b) that supplies, to the fourth load device (16b) the DC electrical power output from the second electrical power generating device, the second connection circuit (18a) equipped with the second connection device (20a) that is capable of connecting the third electrical power supply circuit and the fourth electrical power supply circuit, the third electrical power storage device (24b) connected, in parallel with the second electrical power generating device, to the fourth electrical power supply circuit, and the fourth electrical power storage device (34a) connected, in parallel with the second electrical power generating device, to the second connection circuit, the fourth electrical power storage device having the rated output voltage lower than the rated output voltage of the third electrical power storage device.

### Supplementary Note 7

The electrical power supply system according to Supplementary Note 1 may further include the control device (40) that is capable of executing the control to restart the first electrical power generating device by supplying the electrical power from the second electrical power storage device to the first electrical power generating device.

### Supplementary Note 8

The electrical power supply system (10) according to the present disclosure includes the electrical power supply circuit (12c) that supplies, to the load device (16c), the DC electrical power output from the electrical power generating device (14a), the first electrical power storage device (24c) connected, in parallel with the electrical power generating device, to the electrical power supply circuit, the reverse flow prevention device (28c) that is provided in the electrical power supply circuit, and limits the supply of the electrical power from the first electrical power storage device to the electrical power generating device, and the second electrical power storage device (34b) connected, in parallel with the electrical power generating device, to a portion of the electrical power supply circuit that is positioned between the electrical power generating device and the reverse flow prevention device, the second electrical power storage device having the rated output voltage lower than the rated output voltage of the first electrical power storage device.

According to the above-described configuration, in the case that the electrical power generating device is stopped, the electrical power generating device can be restarted by supplying an electrical power from the electrical power storage device to the electrical power generating device. In accordance with such a configuration, it is possible to provide a more satisfactory electrical power supply system.

### Supplementary Note 9

The moving object (50) according to the present disclosure includes the electrical power supply system according to any one of Supplementary Notes 1 to 8.

In accordance with such a configuration, it is possible to provide a moving object including a more satisfactory electrical power supply system.

Although concerning the present disclosure, a detailed description thereof has been presented above, the present disclosure is not necessarily limited to the individual embodiments described above. These embodiments may be subjected to various additions, substitutions, modifications, partial deletions and the like, within a range that does not deviate from the essence and gist of the present disclosure, or the spirit of the present disclosure as derived from the content described in the claims and equivalents thereof. Further, the embodiments can also be implemented together in combination. For example, in the above-described embodiments, the order of the operations and the order of the processes are illustrated as examples, and the present disclosure is not necessarily limited to these features. The same also applies to cases in which numerical values or mathematical expressions are used in the description of the aforementioned embodiments.

1. An electrical power supply system, comprising:
a first electrical power supply circuit configured to supply, to a first load device, a direct-current electrical power output from a first electrical power generating device;
a second electrical power supply circuit configured to supply, to a second load device, a direct-current electrical power output from a second electrical power generating device;
a first connection circuit equipped with a first connection device configured to connect the first electrical power supply circuit and the second electrical power supply circuit;
a first electrical power storage device connected, in parallel with the first electrical power generating device, to the first electrical power supply circuit; and
a second electrical power storage device connected, in parallel with the first electrical power generating device, to the first connection circuit, the second electrical power storage device having a rated output voltage lower than a rated output voltage of the first electrical power storage device.

2. The electrical power supply system according to claim 1, further comprising a reverse flow prevention device provided in the first electrical power supply circuit, and configured to limit supply of an electrical power from the first electrical power storage device to the first electrical power generating device,
wherein the first connection circuit is connected to a portion of the first electrical power supply circuit that is positioned between the first electrical power generating device and the reverse flow prevention device.

3. The electrical power supply system according to claim 1, further comprising a disconnection device configured to disconnect the second electrical power storage device from the first connection circuit.

4. The electrical power supply system according to claim 1, further comprising a voltage conversion device that is configured to step down the electrical power supplied from the first electrical power generating device and supply the stepped down electrical power to the second electrical power storage device, and is configured to step up an electrical power supplied from the second electrical power storage device and supply the stepped up electrical power to the first electrical power generating device.

5. The electrical power supply system according to claim 4,
wherein the voltage conversion device is provided in the first connection circuit.

6. The electrical power supply system according to claim 1, further comprising:
a third electrical power supply circuit configured to supply, to a third load device, the direct-current electrical power output from the first electrical power generating device;
a fourth electrical power supply circuit configured to supply, to a fourth load device, the direct-current electrical power output from the second electrical power generating device;
a second connection circuit equipped with a second connection device configured to connect the third electrical power supply circuit and the fourth electrical power supply circuit;
a third electrical power storage device connected, in parallel with the second electrical power generating device, to the fourth electrical power supply circuit; and
a fourth electrical power storage device connected, in parallel with the second electrical power generating device, to the second connection circuit, the fourth electrical power storage device having a rated output voltage lower than a rated output voltage of the third electrical power storage device.

7. The electrical power supply system according to claim 1, further comprising a control device configured to execute a control to restart the first electrical power generating device by supplying an electrical power from the second electrical power storage device to the first electrical power generating device.

8. An electrical power supply system, comprising:
an electrical power supply circuit configured to supply, to a load device, a direct-current electrical power output from an electrical power generating device;
a first electrical power storage device connected, in parallel with the electrical power generating device, to the electrical power supply circuit;
a reverse flow prevention device provided in the electrical power supply circuit, and configured to limit supply of an electrical power from the first electrical power storage device to the electrical power generating device; and
a second electrical power storage device connected, in parallel with the electrical power generating device, to a portion of the electrical power supply circuit that is positioned between the electrical power generating device and the reverse flow prevention device, the second electrical power storage device having a rated output voltage lower than a rated output voltage of the first electrical power storage device.

9. A moving object comprising the electrical power supply system according to claim 1.
